(19) United States
(12) Patent Application Publication
(10) Pub. No.: US 2006/0169531 A1
(43) Pub. Date: Aug. 3, 2006

(54) Component that absorbs airborne sound

(76) Inventor: Christine Volker, Leverkusen (DE)

Correspondence Address: WILLIAM COLLARD;COLLARD & ROE, P.C., 1077 NORTHERN BOULEVARD, ROSLYN, NY, 11576, US

(21) Appl. No.: 10/540,080

(22) PCT Filed: Oct. 21, 2004
(86) PCT No.: PCT/EP04/11899

§ 371 Date: Jun. 22, 2005

(30) Foreign Application Priority Data
Dec. 23, 2003 (DE) 203 20 100.0

(51) Int. Cl. F02B 77/13; E04B 1/82

(52) U.S. Cl. 181/204; 181/293

(57) ABSTRACT

The invention relates to an airborne-sound absorbing component, in particular for motor vehicles, comprising a resonance absorber (1) with a plurality of differently sized hollow chambers (2) spaced apart from each other, and comprising a porous sound-absorbing layer (8) made of an air-permeable material, which layer faces the incoming sound, wherein in each instance the hollow chambers comprise a wall section (5) which faces the incoming sound. The wall sections (5), which face the incoming sound and which are able to oscillate, are closed off so as to be airtight, wherein the resonance absorber (1) comprises one or several spacers (10) such that at least the majority of the wall sections (5) of the hollow chambers (2), which wall sections face the incoming sound, do not establish contact with the porous layer (8) and are able to oscillate independently of said porous layer (8). As a result of these features improved sound absorption capability across a broad frequency range is achieved.

The invention relates to an airborne-sound absorbing component, in particular for motor vehicles, comprising a resonance absorber with a plurality of differently sized hollow chambers spaced apart from each other, and comprising a porous sound-absorbing layer made of an air-permeable material, which layer faces the incoming sound, wherein in each instance the hollow chambers comprise a wall section which faces the incoming sound and is able to oscillate.

For the purpose of sound insulation in motor vehicles, in particular engine compartment shieldings are used which consist of a so-called resonance absorber. Such a resonance absorber is for example described in EP 0 775 354 B1. Resonance absorbers of this type have in principle proven themselves in practical applications. However, they are unsatisfactory in that the degree of their sound absorption drops significantly towards higher sound frequencies.

In contrast to this, pore absorbers consisting of an air-permeable material have a good degree of sound absorption at high frequencies. However, their effectiveness is significantly reduced towards low frequencies.

An airborne-sound absorbing formed component of the type mentioned in the introduction is known from DE 40 11 705 C2. On its surface facing the source of the sound, this formed component comprises Helmholtz resonators of various resonance frequencies. The Helmholtz resonators are arranged in such a way that the neighbouring Helmholtz resonators which are located in the sphere of influence of the respective lower-frequency Helmholtz resonator all have different resonance frequencies and are arranged over the entire surface. The surface of the formed component which carries the resonators is designed as a plate absorber which encompasses the Helmholtz resonators with positive fit, thus leaving their openings free. In one variant, the surface of this formed component, which surface faces the incoming sound, is covered by a porous layer which consists of a glued-on non-woven material or an open-pore cellular material.

It is the object of the present invention to create an airborne-sound absorbing component of the type mentioned in the introduction, which component provides improved sound absorption capabilities across a wide frequency range.

According to the invention this object is met by the component defined in claim 1.

The airborne-sound absorbing component according to the invention comprises a resonance absorber which has a plurality of hollow chambers of different sizes spaced apart from each other. Each hollow chamber comprises a wall section which faces the incoming sound, is closed off so as to be airtight, and is able to oscillate. Furthermore, there is a porous sound-absorbing layer made of an air permeable material, which layer also faces the incoming sound. The resonance absorber is provided with at least one spacer, such that at least the majority of the wall sections of the hollow chambers, which wall sections face the incoming sound, do not establish contact with the porous layer and are able to oscillate independently of said porous layer.

The component according to the invention features an improved degree of sound absorption, wherein the degree of sound absorption in a wide frequency range, namely in particular in the medium-frequency and high-frequency range from approximately 400 to approximately 10,000 Hz, on the whole is above the degree of sound absorption of a conventional resonance absorber. The component according to the invention thus has improved broadband sound absorption capacity. To accomplish this, the component according to the invention needs hardly any more design space; a factor which is advantageous in view of the limited design space available in motor vehicles, in particular in an engine compartment. In this context it is in particular advantageous that as a result of the sound-absorbing layer arranged in front of the resonance absorber the spaces between the hollow chambers, on the side of the resonance absorber, which side faces the incoming sound, can be used for sound absorption too.

According to a preferred embodiment, the spacer or spacers is/are designed such that they form one piece with the resonance absorber. This saves at least one of the process steps during production of the component according to the invention, thus resulting in correspondingly favourable production costs. As far as the strength and the design of the spacers are concerned, it can, however, also be advantageous to produce them separately and finally to connect them to the resonance absorber and/or the porous sound-absorbing layer, for example to paste them to, weld them to or, if the connection is designed accordingly, to clip-lock them to the resonance absorber and/or the porous sound-absorbing layer.

Another advantageous embodiment of the component according to the invention consists in that the spacers have different distance dimensions in relation to a common reference level which is situated on an outside of the resonance absorber. In particular it is provided for the porous layer to comprise sections which are spaced apart at different distances from a mutual reference level which is situated on an outside of the resonance absorber. It is thus possible to adapt the contour or the spacing of the porous layer not only in relation to the topography of the hollow chambers, but also in relation to the contour of an adjacent unit, in particular to the contour of an internal combustion engine or some other source of sound.

The porous sound-absorbing layer of the component according to the invention can in particular be made from a layer of non-woven material and/or a layer of an open-cell cellular material.

A further advantageous embodiment of the component is characterised in that on the outside the porous layer comprises a micro-perforated metal foil, in particular a micro-perforated aluminium foil. In this way it is possible, if required, to provide the component according to the invention with sufficient heat resistance. In particular, if necessary, this embodiment makes it possible to use the component according to the invention as an airborne-sound absorbing heat shield.

In this context, a further advantageous embodiment of the component according to the invention consists in that the porous layer is formed from several layers of a knitted aluminium material which are pressed together to form a mat. When compared to a single micro-perforated aluminium foil, the sound absorption capability of such a mat is more favourable. In addition, said mat also provides a high reflection capability to heat radiation.

In order to secure the existing sound absorption capability of the porous layer in an engine compartment of a motor vehicle in the long term, a further embodiment of the component according to the invention provides for the porous layer to have a hydrophobic finish and/or an oleophobic finish.

As far as a later recycling of the component according to the invention is concerned, the porous layer and the resonance absorber can preferably be made from plastics belonging to the same materials class. As an alternative or as a supplement to this, it is also advantageous if the porous layer is disconnectably connected to the resonance absorber so that separation according to types, of any different plastics types used, is easily possible.

Further preferred and advantageous embodiments of the invention are stated in the subordinate claims.

Below, the invention is explained in more detail with reference to a drawing which shows several embodiments. The following are diagrammatically shown:

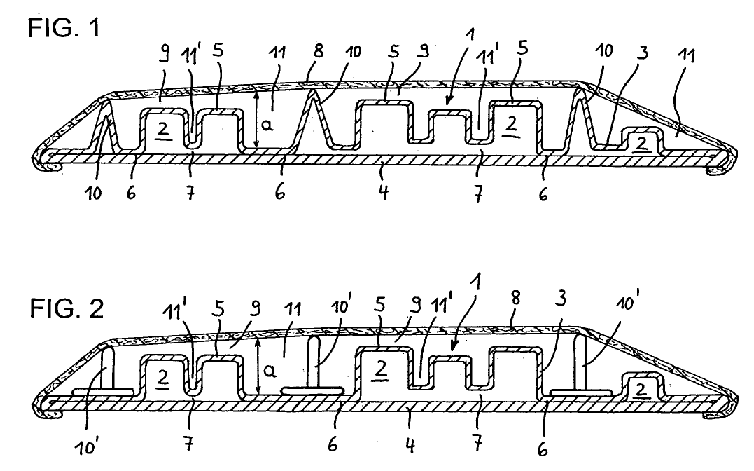

FIG. 1: a cross-sectional view of a first embodiment of a component according to the invention;

FIG. 2: a cross-sectional view of a second embodiment of a component according to the invention;

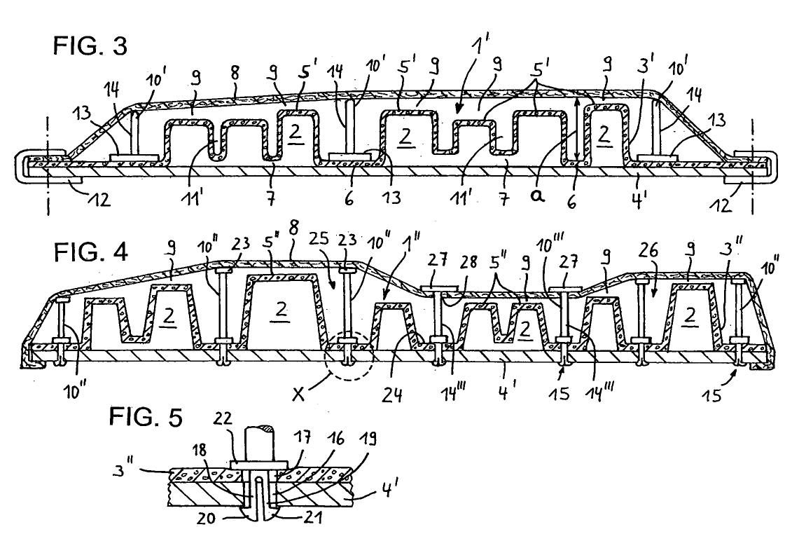

FIG. 3: a cross-sectional view of a third embodiment of a component according to the invention;

FIG. 4: a cross-sectional view of a fourth embodiment of a component according to the invention;

FIG. 5: an enlarged detail view of detail X in FIG. 4;

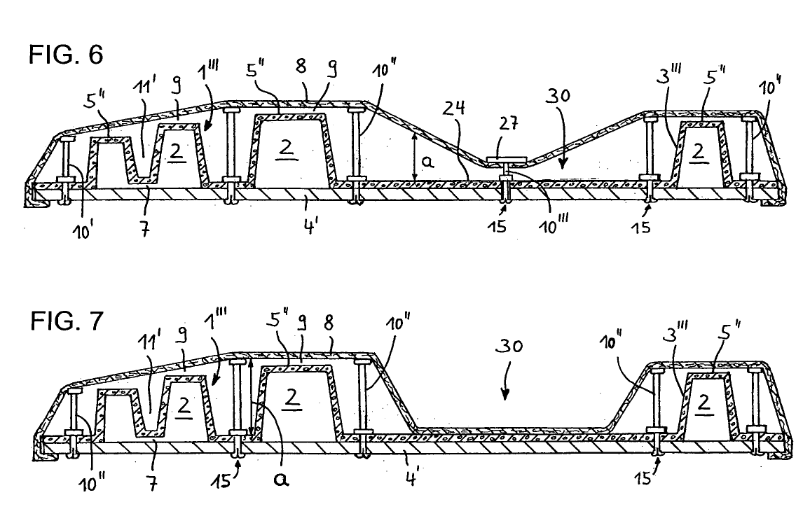

FIG. 6: a cross-sectional view of a fifth embodiment of a component according to the invention; and

FIG. 7: a cross-sectional view of a sixth embodiment of a component according to the invention.

In FIG. 1 there is illustrated a first embodiment of an airborne-sound absorbing component according to the invention. The component is made of a resonance absorber 1 with a plurality of differently sized hollow chambers 2, spaced apart from each other. In this embodiment, the resonance absorber 1 is a blow-moulded plastic component which can be produced by extrusion blow-moulding. The blow-moulded component is made from an extruded plastic hose section which comprises initial wall dimensions of different thickness. The starting material can for example be polypropylene, in particular fibre-reinforced polypropylene.

The finished resonance absorber 1 comprises a structural component 3 and a bottom component or carrier component 4, connected in one piece to said structural component 3, wherein the hollow chambers 2 are formed in the structural component 3. The structural component 3 is formed from the material section of the extruded plastic hose, whose wall thickness is smaller than that of the material section from which the carrier component 4 is made.

The hollow chambers 2 are box-shaped or cup-shaped and form part of a common air space which is enclosed between the structural component 3 and the bottom component or carrier component 4. The hollow chambers 2 are open on one side wherein their wall sections 5, which are able to oscillate, are closed off so as to be airtight.

It is shown that the hollow chambers 2 are different in height as well as in the size of their base surface. Between the chamber walls of the structural component 3 and the carrier component 4 there are weld connections 6, either in the shape of points or lines. In particular, hollow chambers 2 are provided whose chamber walls at essentially identical height are partly welded to the carrier component 4 and partly face the carrier component 4 so as to form a free collar, namely by leaving an air gap 7 between a face of the chamber wall and the carrier component 4.

The airborne-sound absorbing component further comprises a porous sound-absorbing layer 8 of air-permeable material, which layer faces the incoming sound. The porous layer 8 extends at a distance to the wall sections 5 of the hollow chambers 2 so as to leave an air-filled free space 9. In order to create or maintain the respective free space 9 between the porous air-permeable layer 8 and the wall sections 5 which are able to oscillate and which face the incoming sound, the resonance absorber 1 is provided with several spacers. The spacers 10 are arranged between the hollow chambers 2 and at a distance from them. Said spacers 10 are dimensioned and arranged such that at least the majority of the wall sections 5 of the hollow chambers 2 do not establish contact with the porous layer 8 and remain able to oscillate independently of said porous layer 8.

The material of layer 8 can in particular be a non-woven and/or an open-cell cellular material foil. The material is preferably finished so as to be hydrophobic (water-repellent) and/or oleophobic (oil-repellent). The porous layer 8 is less than 2 mm in thickness. Preferably, the thickness of the layer 8 is in the range from 50 μm to 1 mm.

At its margin, the porous layer 8 is connected to the resonance absorber 1 so that an air space 11 is defined between the structural component 3 and the layer 8. The height of the airspace 11 or the distance a between the resonance absorber 1 and the porous layer 8 ranges from 0 to 40 mm. In the region above the wall sections 5 of the hollow chambers 2, the distance a may at times only range from 3 to 5 mm. The connection between the porous layer 8 and the resonance absorber 1 can be implemented by interrupted or by continuous welding or pasting.

As a result of the porous layer 8, in particular also the spaces 11′ between the hollow chambers 2 are utilised for sound absorption.

In the embodiment shown in FIG. 1, the spacers 10 are designed so as to be in a single piece with the structural component of the resonance absorber 1. Said spacers, just like the hollow chambers 2 which are used as resonators, are formed during blow-moulding. However, they are not box-shaped or cup-shaped but instead essentially funnel-shaped and/or trough-shaped, wherein they comprise an essentially V-shaped cross section. Corresponding to the different heights of the hollow chambers 2, the spacers 10 define different distance dimensions in relation to a mutual reference level which is situated on the outside or inside of the resonance absorber 1.

FIG. 2 shows a second embodiment, which differs from the previous embodiment essentially by the design of the spacers. The spacers 10′ shown are not formed by blow-moulding. Instead they are produced separately, for example as injection-moulded components, and at selected positions are welded or glued to the resonance absorber 1 so as to be at a distance to the hollow chambers 2 of the structural component 3. As an alternative, the spacers 10′ can also be directly injection moulded to the structural component 3 of the resonance absorber 1.

Preferably, the resonance absorber 1 shown in FIGS. 1 and 2 is a blow-moulded component. However, in principle it is also possible to produce such a resonance absorber as a plastic injection-moulded component.

FIG. 3 shows a further embodiment of an airborne-sound absorbing component according to the invention. Again, the resonance absorber 1′ is made from a carrier component 4′ and a structural component 3′ comprising a multitude of box-shaped or cup-shaped hollow chambers 2. However, in this embodiment the structural component 3′ and the carrier component 4′ are components which have been produced separately, wherein the structural component 3′ comprises a closed-cell cellular material foil, formed by swaging (deep-drawing), for example made of polyethylene or polypropylene.

In this embodiment, too, the hollow chambers 2 are made in such a way that their chamber walls while essentially of the same height are partly welded to the carrier component 4′ and partly face the carrier component 4′ so as to form a free collar so that there is an air gap 7 between a face of the chamber wall and the carrier component 4′, and that the hollow chambers 2 thus form part of a mutual air space which is enclosed between the structural component 3′ and the carrier component 4.

The hollow chambers 2 are covered by a porous layer 8 made of an air-permeable material, with said porous layer 8 being disconnectably connected to the margin of the resonance absorber 1′. The connection is implemented by u-shaped metal clips and/or clip-on rails, wherein these clip-like connection elements 12 as well as the margin area of the resonance absorber 1′ and of the porous layer 8 comprise mutually aligned bore holes for inserting attachment screws or similar fasteners.

As in the case of the previously described embodiments, the resonance absorber 1′ is provided with several spacers 10′ which are arranged between hollow chambers 2 and are spaced apart from these. The spacers 10′ are injection-moulded plastic components, which are glued to or welded to the structural component 3′ of the resonance absorber 1′. They comprise a base section 13, supported on the structural component, and a bar-shaped or web-shaped section 14, connected in one piece to said base section 13. The bar-shaped or web-shaped sections 14 are dimensioned such that the porous layer 8 does not rest against the wall sections 5′ of the hollow chambers 2, which wall sections 5′ face the incoming sound. This ensures that the wall sections 5′ are not subjected to any loads by the porous layer 8, and are thus able to oscillate independently of said porous layer 8.

The air-filled empty spaces 9, which are formed by the spacers 10′ between the porous layer 8 and the wall sections 5′ of the hollow chambers 2, which wall sections 5′ face the incoming sound, are again of different heights.

In the embodiment shown in FIG. 4, the spacers 10″, 10″′ are connectable or clip-lockable with positive fit to the carrier component 4′ of the resonance absorber 1″. The spacers 10″, 10″′ are injection-moulded plastic components. Each of them has a plug-in end 15, shown as an enlargement in FIG. 5. The plug-in end 15 is slotted in longitudinal direction and can be locked to an opening 16 (punched hole) made in the carrier component 4′. Associated with the opening 16 is an opening 17 (punched hole), aligned with the former, in the structural component 3″. The internal diameters of both openings 16, 17 are essentially identical. The plug-in end 15 comprises two elastically compressible limbs 18, 19 at the ends of which locking projections 20, 21 are formed that protrude outward. The locking projections 20, 21 are bevelled or rounded off in the direction of plug-in so that they, and thus the elastic limbs 18, 19, are brought together when they are inserted in the openings 17, 16; and return to their original position when they exit the opening 16. The internal diameter of the opening 16 is somewhat smaller than the largest external diameter formed by the locking projections 20, 21. The length of the plug-in end 15 is delimited by an end stop 22. The distance between the flange-like end stop 22 and the locking projections 20, 21 is somewhat smaller than the wall thickness, which in this position comprises the carrier component 4′ and the structural component 3″. However, since in this embodiment the structural component 3″ comprises an elastically compressible cellular material foil, the plug-in end 15, while slightly compressing the close-cell cellular material foil, can be clip-locked without any problems and without any play in the opening 16 of the carrier component 4′.

The structural component 3″ of the resonance absorber 1″ according to FIG. 4 comprises a multitude of cup-shaped hollow chambers 2 which differ in size and in particular in height. The spacers 10″ and 10″′ here comprise two groups of spacers. On the first group of spacers 10″ the porous layer 8 is supported in such a way that the wall sections 5″ of the hollow chambers 2, which wall sections 5″ face the incoming sound, do not have any contact with the porous layer 8 and are able to oscillate independently of said porous layer 8. Preferably, each of the spacers 10″ of this group have a head 23 with an enlarged diameter, which head 23 serves as a support surface for the layer 8.

The second group of spacers 10″′ reduces the distance between the porous layer 8 and the base plane 24 of the structural component 3″ between two positions 25 and 26 where this distance is greater. When compared to the spacers 10″ of the first group, the spacers 10″′ of this group comprise larger disc-shaped heads 27 against whose bottom the top of the porous layer 8 rests. In the region of the disc-shaped heads 27, the porous layer 8 comprises an opening 28 through which the bar-shaped section 14″′ of the spacer 10″′, which section 14″′ carries the plug-in end 15, leads. The diameter of the disc-shaped head 27 is considerably larger than the diameter of the opening 28 in the porous layer 8, which opening 28 is associated with said disc-shaped head 27. While the spacers 10″ of the first group are subjected to pressure, the spacers 10″′ of the second group are subjected to a certain tensile load.

With the use of spacers 10″′ of the second group, the gradient or the contour of the porous layer 8 can be adapted relatively precisely to the envelope or contour of the structural component 3″ while maintaining air spaces 9 above the wall sections 5″ of the hollow chambers 2, which wall sections 5″ face the incoming sound and are able to oscillate. This can in particular be of advantage for non-contacting adaptation of the component according to the invention in relation to units arranged above said component, for example an oil sump or a cylinder head.

FIGS. 6 and 7 show two embodiments in which a resonance absorber 1″′ comprises a larger region 30 in which there are no hollow chambers 2. The absence of hollow chambers can be dictated by a lack of space at the place of installation. For example, a gearbox, an oil sump or some other unit can take up the space required for providing hollow chambers 2. In such cases it is, however, still possible to arrange the porous acoustically effective layer 8 in the region 30 that is not occupied by hollow chambers, in order to use this region too for reducing the sound emissions that occur.

The air which is enclosed between the outside of the resonance absorber 1″′ , which outside faces the sound, and the porous layer 8, at least in some regions, acts like a spring of a spring-mass system, wherein the air present in the pores of the layer 8 and/or the oscillatable porous layer 8 itself forms the mass of the system.

In the embodiment according to FIG. 6 at least one spacer 10″′ is provided, with which the porous layer 8 in the larger region 30, which does not comprise hollow chambers 2, is pulled near to the base plane 24 or the bottom of the structural component 3″′ of the resonance absorber 1″′.

In the embodiment according to FIG. 7, the porous layer 8 in the larger region 30 of the resonance absorber 1″′, which region 30 does not comprise any hollow chambers 2, is led right down to the top of said resonance absorber 1″′. In this region, the layer 8 and the resonance absorber 1″′ can be glued together, welded together or interconnected using attachment means (not shown) such as rivets, locking elements or the like.

The airborne-sound absorbing components described above can be used in motor vehicles, in particular as engine compartment encapsulation components and/or as a underbody lining, and can be prepared accordingly. In these arrangements, the porous air-permeable layer 8 can on the outside be partially or entirely lined or covered so as to be free of adhesive, by a micro-perforated heat-shielding aluminium foil (not shown). As an alternative, the layer 8 can also comprise several layers of aluminium knitted goods, compressed to form a microporous mat, which also acts as a heat shield.

Implementation of the invention is not limited to the exemplary embodiments described above. Instead, numerous modifications are imaginable, which, even if they deviate in their principal design, make use of the inventive idea contained in the claims. In particular, the features of the exemplary embodiments described above can be combined with each other. It is also within the scope of the invention to use the walls of one or several hollow chambers 2 as spacers if necessary. These hollow chambers then practically serve a double function in that they serve as resonators on the one hand, and as spacers on the other hand.

1. An airborne-sound absorbing component, in particular for motor vehicles, comprising a resonance absorber (1, 1′, 1″, 1″′) with a plurality of differently sized hollow chambers (2) spaced apart from each other, and comprising a porous sound-absorbing layer (8) made of an air-permeable material, which layer (8) faces the incoming sound, wherein in each instance the hollow chambers (2) chambers comprise a wall section (5, 5′, 5″) which faces the incoming sound, wherein the wall sections (5, 5′, 5″) which face the incoming sound and are able to oscillate are closed off so as to be airtight, wherein the resonance absorber (1, 1′, 1″, 1″′) comprises one or several spacers (10, 10′, 10″, 10″′) such that at least the majority of the wall sections (5, 5′, 5″) of the hollow chambers (2), which wall sections (5, 5′, 5″) face the incoming sound, do not establish contact with the porous layer (8) and are able to oscillate independently of said porous layer (8).

2. The component according to claim 1, wherein the spacers (10, 10′) are designed such that they form one piece with the resonance absorber (1).

3. The component according to claim 1, wherein the spacers (10′) are glued or injection-moulded to the resonance absorber (1).

4. The component according to claim 1, wherein the spacers (10′, 10″′) are held with positive fit to the resonance absorber (1″, 1″′) and/or are clip-lockable.

5. The component according to claim 1, wherein the spacers (10, 10′, 10″, 10″′) are arranged between hollow chambers (2) and spaced apart from these.

6. The component according to claim 1, wherein the spacers (10, 10′, 10″, 10″′) have different distances from a mutual reference level which is situated on an outside or inside of the resonance absorber (1, 1′, 1″, 1″′).

7. The component according to claim 1, wherein air-filled voids, which are ensured by the spacer or spacers (10, 10′, 10″, 10″′) between the porous layer (8) and the wall sections (5, 5′, 5″) of the hollow chambers (2), which wall sections (5, 5′, 5″) face the incoming sound and are able to oscillate, differ in height.

8. The component according to claim 1, wherein the porous layer (8) comprises sections which are spaced apart differently in relation to a common reference level which is situated on an outside of the resonance absorber (1″).

9. The component according to claim 1, wherein the porous layer (8) is made from a layer of non-woven material and/or a layer of an open-cell cellular material.

10. The component according to claim 1, wherein on the outside, the porous layer (8) is covered by a micro-perforated metal foil.

11. The component according to claim 1, wherein the porous layer (8) is formed from several layers of knitted aluminium goods which are pressed together to form a mat.

12. The component according to claim 1, wherein the hollow chambers (2) are of different height.

13. The component according to claim 1, wherein at least several of the hollow chambers (2) are open on one side and form part of a common air space enclosed in the resonance absorber (1, 1′, 1″, 1″′).

14. The component according to claim 1, wherein the resonance absorber (1) is a blow-moulded component.

15. The component according to claim 1, wherein the resonance absorber (1′, 1″, 1″′) is or comprises a formed component made by swaging.

16. The component according to claim 1, wherein the resonance absorber (1′, 1″, 1″′) is formed of a closed-cell cellular material foil.

17. The component according to claim 1, wherein the resonance absorber (1, 1′, 1″, 1″′) comprises a structural component (3, 3′, 3″, 3″′) and a carrier component (4, 4′) connected to it, wherein the hollow chambers (2) are formed in the structural component (3, 3′, 3″, 3″′), and the structural component (3, 3′, 3″, 3″′) is formed from a material section whose wall thickness is smaller than that of a material section from which the carrier component (4, 4′) is formed.

18. The component according to claim 1, wherein the resonance absorber (1) is or comprises a formed component made by injection moulding.

19. The component according to claim 1, wherein at its margin, the porous layer (8) is connected to the resonance absorber (1, 1′, 1″, 1″′).

20. The component according to claim 1, wherein a circumferential margin area of the porous layer (8) is connected to the resonance absorber (1, 1″).

21. The component according to claim 1, wherein the porous layer (8) is disconnectably connected to the resonance absorber (1′).

22. The component according to claim 1, wherein the porous layer (8) has a hydrophobic finish and/or an oleophobic finish.

23. The component according to claim 1, wherein the porous layer (8) and the resonance absorber (1, 1′, 1″, 1″′) are made from plastics belonging to the same materials class.

24. The component according to claim 1, wherein it is designed as an engine compartment encapsulation component and/or a underbody lining for a motor vehicle.
